(19) United States
(12) Patent Application Publication
(10) Pub. No.: US 2011/0022620 A1
(43) Pub. Date: Jan. 27, 2011

(54) METHODS AND SYSTEMS FOR ASSOCIATING AND PROVIDING MEDIA CONTENT OF DIFFERENT TYPES WHICH SHARE ATRRIBUTES

(75) Inventor: Thomas Steven Woods, Arlington Heights, IL (US)

Correspondence Address: ROPES & GRAY LLP, PATENT DOCKETING 39/361, 1211 AVENUE OF THE AMERICAS, NEW YORK, NY, 10036-8704, US

(73) Assignee: Gemstar Development Corporation, Santa Clara, CA (US)

(21) Appl. No.: 12/510,005

(22) Filed: Jul. 27, 2009

(51) Int. Cl. G06F 17/30

(52) U.S. Cl. 707/769; 707/E17.009; 707/E17.108

(57) ABSTRACT

Systems and methods are provided for associating and providing media content of different types which share attributes. When an audio asset is selected for playback, visual media content, which includes the audio asset, may be identified and associated with the audio asset. The realted visual media content may be displayed during playback of the audio asset to provide a compelling visual component during audio asset playback.

### BACKGROUND OF THE INVENTION

This application relates to interactive media guidance applications and more particularly to associating and providing media content of different types which share at least one attribute.

Traditional media center technology allows users to listen to their personal music content through the television. Since music is not a visual medium, traditional technology typically allows for either display of album art associated with the music track currently playing, graphical designs, or a visual montage of the user's personal photos, which are digitally stored somewhere in the home.

Although these methods may provide an engaging experience at first, the novelty soon wears off and users may grow tired of the same album art they have seen many times or the same photos scrolling over and over. As a result of the traditional systems lacking engaging visual content, users may become disinterested and the music may remain merely an auditory only experience.

### SUMMARY OF THE INVENTION

In view of the foregoing, it would be desirable to provide systems and methods for associating audio assets with visual media content. In particular, it would be desirable to provide a system that identifies visual media content which includes at least a portion of the selected audio asset, and displays the visual media content during playback of the audio asset.

In certain embodiments, a user may select a audio asset for playback. For example, a user may select a music track from a play list. In some embodiments, the audio asset may be automatically selected, for example, by control circuitry. In response to selecting an audio asset for playback, one or more sources may be searched individually or in combination to identify at least a portion of visual media content that includes at least a portion of the selected audio asset. The search may be repeated every time an audio asset is selected for playback. The source may be a database, the Internet, a hard drive, a remote device, a mobile device, a server or any other suitable source. The visual media content may be movies, movie clips, television shows, music videos, video games, Internet content, real-time feeds, celebrity photos from the content, concept artwork from film story boards, location shots, behind-the-scenes photos, or any other suitable visual media content. In some embodiments, the visual media content may be one or more scenes from a movie during which the audio asset is played.

In certain embodiments, searching includes retrieving meta-data associated with the audio asset, and basing the search on the retrieved meta-data. The meta-data associated with the audio asset may include the title of the audio asset, one or more artist names associated with the audio asset, a date associated with the audio asset, or any other suitable meta-data. For example, a search may be performed based on the title meta-data of a music track.

When visual media content is identified, it may be associated with the selected audio asset. In certain embodiments, a plurality of visual media content may be identified during a search, and associating the audio asset includes linking the audio asset with one of the plurality of visual media content. In certain embodiments, the searching and associating are performed continuously as the audio asset is being played back.

In some embodiments, the associating further includes adding an entry associated with the audio asset and an identifier for the identified visual media content that is linked to the entry to a database. For example, all visual media content identified during a search may be added to a database linked to a particular audio asset.

After visual media content is associated with the selected audio asset, one or more of the plurality of identified visual media content may be displayed during playback of the audio asset. In particular, a user may select specific visual media content for display during audio asset playback, or visual media content may automatically be selected (e.g., by control circuitry). In certain embodiments, a user account may automatically be charged for displaying visual media content. In some embodiments, an option may be provided to a user to place an order for identified visual media content associated with the selected audio asset, and the identified visual media content may be displayed in response to receiving a user selection of the option.

In certain embodiments, a user may be provided with the option to specify the type of visual media content that is displayed. For example, a user may choose to display only “Television Shows” and “Movies” during playback of a particular audio asset. Additionally, the search of a source may be restricted to the type of visual content specified by the user. For example, if a user chooses only to display “Television Shows” and “Movies”, then a search may be restricted to only TV and Movie visual media content.

In certain embodiments, a search may be performed to identify a plurality of media assets related to the identified visual media content. Identifiers representing each of the plurality of media assets may be displayed. For example, if a user selects particular visual media content (e.g., a television show) to be displayed during playback of an audio asset, media content (e.g., character biographies) related to the television show may be displayed to the user. This allows the user to be introduced to media content that they will most likely enjoy. In certain embodiments, the identifiers representing the plurality of media assets may be interactive (e.g., selectable by a user). In particular, a user may select a visual asset identifier, and the media asset associated with the identifier may be provided. Media assets may be audio assets, visual media assets, movie assets, television show asset, music videos asset, video game assets, print media assets, Internet video content assets, or any other suitable media assets. In some embodiments, the visual media content and the media asset are different.

In certain embodiments, in response to selection of an audio asset, data associated with the selected audio asset may be transmitted to a third party service, and the searching and associating may be performed by the third party service. In some embodiments, the searching includes applying an audio recognition process that cross-references audio frequency data associated with the audio asset with audio frequency data associated with the visual media content. In some embodiments, the third party service may associate the audio asset with the visual media content by comparing meta-data associated with visual media content that is stored to a database, with meta-data associated with the audio asset and match visual media content with the audio asset based, at least in part, on the meta-data.

In certain embodiments, a system for associating audio assets and visual media includes a processor configured to carry out the steps as described above.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with an embodiment of the invention;

FIG. 3 shows an illustrative user equipment device in accordance with another embodiment of the invention;

FIG. 4 is a diagram of an illustrative cross-platform interactive media system in accordance with another embodiment of the invention;

FIG. 5 is an illustrative display of a playlist menu screen in accordance with another embodiment of the invention;

FIG. 6 is an illustrative display of a related media menu screen in accordance with another embodiment of the invention;

FIG. 7 is an illustrative display of a visual media content display screen according to another embodiment of the invention;

FIG. 8 is an illustrative display of a content specification menu according to another embodiment of the invention;

FIG. 9 is an illustrative display of a menu providing media related to displayed visual media content according to another embodiment of the invention;

FIGS. 10A and 10B show systems for associating music and visual media content in accordance with other embodiments of the invention;

FIG. 11 shows an exemplary data structure for an audio asset in accordance with another embodiment of the invention;

FIG. 12 shows an exemplary data structure for a media associating database in accordance with another embodiment of the invention; and

FIGS. 13 and 14 are illustrative flow diagrams for associating audio assets and visual media content in accordance with embodiments of the present invention.

### DETAILED DESCRIPTION OF EMBODIMENTS

The amount of media available to users in any given media delivery system can be substantial. Consequently, many users desire a form of media guidance through an interface that allows users to efficiently navigate media selections and easily identify media that they may desire. An application which provides such guidance is referred to herein as an interactive media guidance application or, sometimes, a media guidance application or a guidance application.

Interactive media guidance applications may take various forms depending on the media for which they provide guidance. One typical type of media guidance application is an interactive television program guide. Interactive television program guides (sometimes referred to as electronic program guides) are well-known guidance applications that, among other things, allow users to navigate among and locate many types of media content including conventional television programming (provided via traditional broadcast, cable, satellite, Internet, or other means), as well as pay-per-view programs, on-demand programs (as in video-on-demand (VOD) systems), Internet content (e.g., streaming media, downloadable media, Webcasts, etc.), and other types of media or video content. Guidance applications also allow users to navigate among and locate content related to the video content including, for example, video clips, articles, advertisements, chat sessions, games, etc. Guidance applications also allow users to navigate among and locate multimedia content. The term multimedia is defined herein as media and content that utilizes at least two different content forms, such as text, audio, still images, animation, video, and interactivity content forms. Multimedia content may be recorded and played, displayed or accessed by information content processing devices, such as computerized and electronic devices, but can also be part of a live performance. It should be understood that the invention embodiments that are discussed in relation to media content are also applicable to other types of content, such as video, audio and/or multimedia.

With the advent of the Internet, mobile computing, and high-speed wireless networks, users are accessing media on personal computers (PCs) and other devices on which they traditionally did not, such as hand-held computers, personal digital assistants (PDAs), mobile telephones, or other mobile devices. On these devices users are able to navigate among and locate the same media available through a television. Consequently, media guidance is necessary on these devices, as well. The guidance provided may be for media content available only through a television, for media content available only through one or more of these devices, or for media content available both through a television and one or more of these devices. The media guidance applications may be provided as on-line applications (i.e., provided on a web-site), or as stand-alone applications or clients on hand-held computers, PDAs, mobile telephones, or other mobile devices. The various devices and platforms that may implement media guidance applications are described in more detail below.

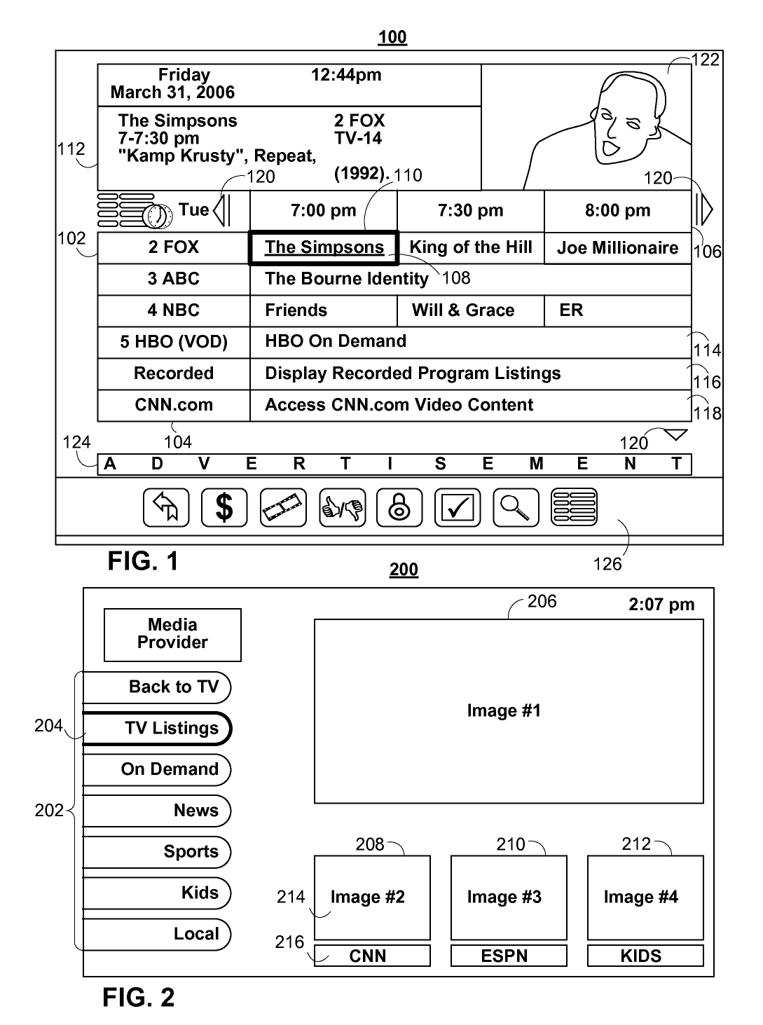

One of the functions of the media guidance application is to provide media listings and media information to users. FIGS. 1-2 show illustrative display screens that may be used to provide media guidance, and in particular media listings. The display screens shown in FIGS. 1-2 and 5-9 may be implemented on any suitable device or platform. While the displays of FIGS. 1-2 and 5-9 are illustrated as full screen displays, they may also be fully or partially overlaid over media content being displayed. A user may indicate a desire to access media information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media information organized in one of several ways, such as by time and channel in a grid, by time, by channel, by media type, by category (e.g., movies, sports, news, children, or other categories of programming), or other predefined, user-defined, or other organization criteria.

FIG. 1 shows illustrative grid program listings display 100 arranged by time and channel that also enables access to different types of media content in a single display. Display 100 may include grid 102 with: (1) a column of channel/media type identifiers 104, where each channel/media type identifier (which is a cell in the column) identifies a different channel or media type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming provided according to a schedule, the media guidance application also provides access to non-linear programming which is not provided according to a schedule. Non-linear programming may include content from different media sources including on-demand media content (e.g., VOD), Internet content (e.g., streaming media, downloadable media, etc.), locally stored media content (e.g., video content stored on a digital video recorder (DVR), digital video disc (DVD), video cassette, compact disc (CD), etc.), or other time-insensitive media content. On-demand content may include both movies and original media content provided by a particular media provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming media or downloadable media through an Internet web site or other Internet access (e.g. FTP).

Grid 102 may provide listings for non-linear programming including on-demand listing 114, recorded media listing 116, and Internet content listing 118. A display combining listings for content from different types of media sources is sometimes referred to as a “mixed-media” display. The various permutations of the types of listings that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In other embodiments, listings for these media types may be included directly in grid 102. Additional listings may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the present invention.

Advertisement 124 may provide an advertisement for media content that, depending on a viewer's access rights (e.g., for subscription programming), is currently available for viewing, will be available for viewing in the future, or may never become available for viewing, and may correspond to or be unrelated to one or more of the media listings in grid 102. Advertisement 124 may also be for products or services related or unrelated to the media content displayed in grid 102. Advertisement 124 may be selectable and provide further information about media content, provide information about a product or a service, enable purchasing of media content, a product, or a service, provide media content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over media content or a guidance application display or embedded within a display. Advertisements may also include text, images, rotating images, video clips, or other types of media content. Advertisements may be stored in the user equipment with the guidance application, in a database connected to the user equipment, in a remote location (including streaming media servers), or on other storage means or a combination of these locations. Providing advertisements in a media guidance application is discussed in greater detail in, for example, Knudson et al., U.S. Patent Application Publication No. 2003/0110499, filed Jan. 17, 2003, Ward, III et al. U.S. Pat. No. 6,756,997, issued Jun. 29, 2004, and Schein et al. U.S. Pat. No. 6,388,714, issued May 14, 2002, which are hereby incorporated by reference herein in their entireties. It will be appreciated that advertisements may be included in other media guidance application display screens of the present invention.

Options region 126 may allow the user to access different types of media content, media guidance application displays, and/or media guidance application features. Options region 126 may be part of display 100 (and other display screens of the present invention), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, access to various types of listing displays, subscribe to a premium service, edit a user's profile, access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of media content listings displayed (e.g., only HDTV programming, user-specified broadcast channels based on favorite channel selections, re-ordering the display of channels, recommended media content, etc.), desired recording features (e.g., recording or series recordings for particular users, recording quality, etc.), parental control settings, and other desired customizations.

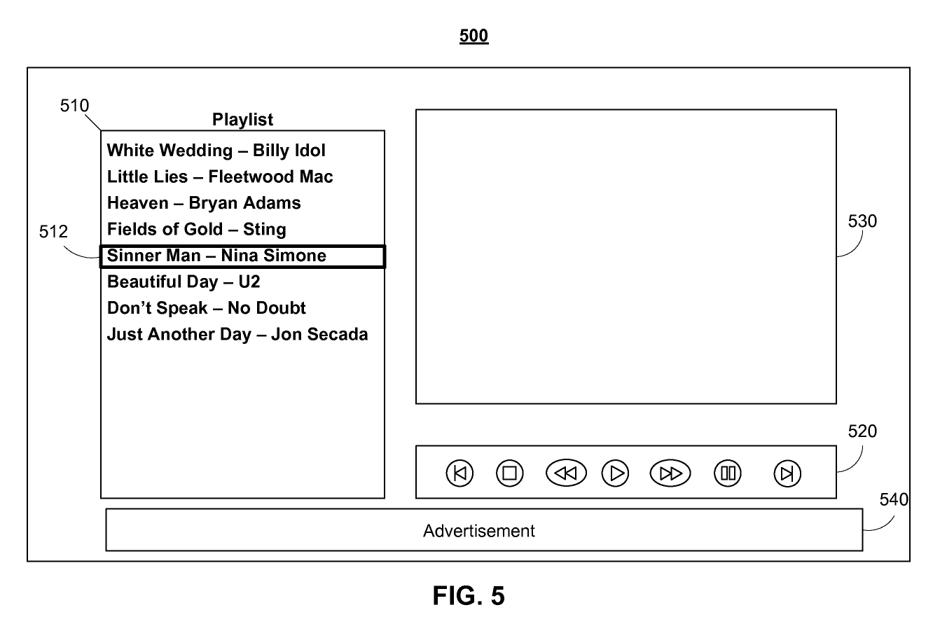

The media guidance application may allow a user to provide user profile information or may automatically compile user profile information. The media guidance application may, for example, monitor the media the user accesses and/or other interactions the user may have with the guidance application. Additionally, the media guidance application may obtain all or part of other user profiles that are related to a particular user (e.g., from other web sites on the Internet the user accesses, such as www.tvguide.com, from other media guidance applications the user accesses, from other interactive applications the user accesses, from a handheld device of the user, etc.), and/or obtain information about the user from other sources that the media guidance application may access. As a result, a user can be provided with a unified guidance application experience across the user's different devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. patent application Ser. No. 09/437,304, filed Nov. 9, 1999, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for media content information organized based on media type, genre, and/or other organization criteria. In display 200, television listings option 204 is selected, thus providing listings 206, 208, 210, and 212 as broadcast program listings. Unlike the listings from FIG. 1, the listings in display 200 are not limited to simple text (e.g., the program title) and icons to describe media. Rather, in display 200 the listings may provide graphical images including cover art, still images from the media content, video clip previews, live video from the media content, or other types of media that indicate to a user the media content being described by the listing. Each of the graphical listings may also be accompanied by text to provide further information about the media content associated with the listing. For example, listing 208 may include more than one portion, including media portion 214 and text portion 216. Media portion 214 and/or text portion 216 may be selectable to view video in full-screen or to view program listings related to the video displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the media provider or based on user preferences. Various systems and methods for graphically accentuating media listings are discussed in, for example, Yates, U.S. patent application Ser. No. 11/324,202, filed Dec. 29, 2005, which is hereby incorporated by reference herein in its entirety.

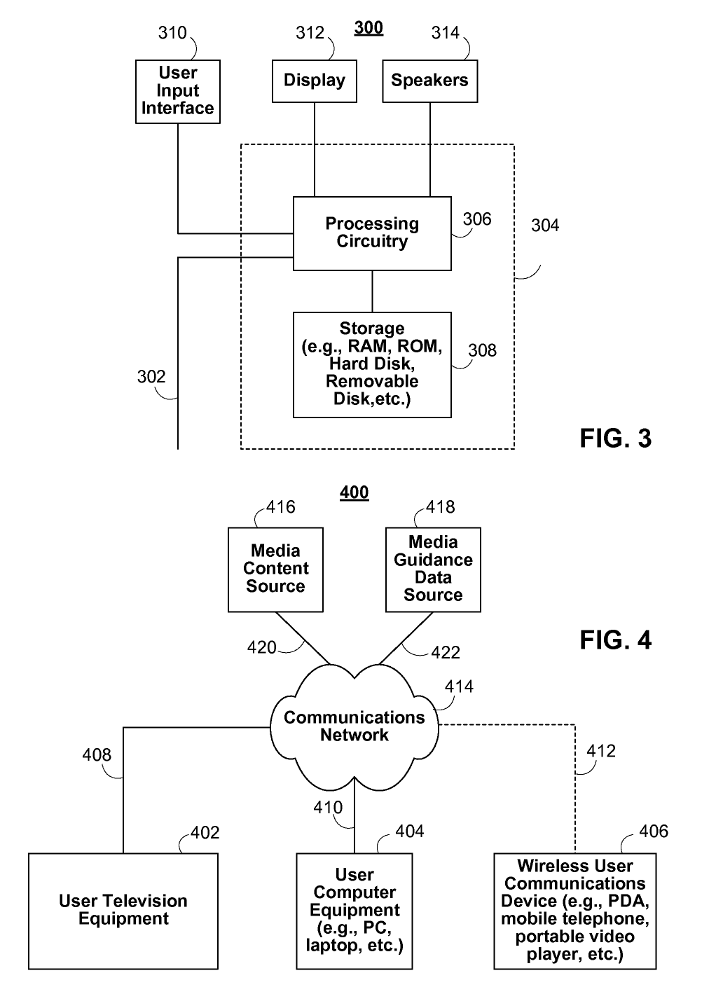

Users may access media content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive media content and data via input/output (hereinafter “I/O”) path 302. I/O path 302 may provide media content (e.g., broadcast programming, on-demand programming, Internet content, and other video or audio) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry 306 such as processing circuitry based on one or more microprocessors, microcontrollers, digital signal processors, programmable logic devices, etc. In some embodiments, control circuitry 304 executes instructions for a media guidance application stored in memory (i.e., storage 308). In client-server based embodiments, control circuitry 304 may include communications circuitry suitable for communicating with a guidance application server or other networks or servers. Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 308 that is part of control circuitry 304. Storage 308 may include one or more of the above types of storage devices. For example, user equipment device 300 may include a hard drive for a DVR (sometimes called a personal video recorder, or PVR) and a DVD recorder as a secondary storage device. Storage 308 may be used to store various types of media described herein and guidance application data, including program information, guidance application settings, user preferences or profile information, or other data used in operating the guidance application. Nonvolatile memory may also be used (e.g., to launch a boot-up routine and other instructions).

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting media into the preferred output format of the user equipment 300. Circuitry 304 may also include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may control the control circuitry 304 using user input interface 310. User input interface 310 may be any suitable user interface, such as a remote control, mouse, trackball, keypad, keyboard, touch screen, touch pad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. Speakers 314 may be provided as integrated with other elements of user equipment device 300 or may be stand-alone units. The audio component of videos and other media content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from the VBI of a television channel, from an out-of-band feed, or using another suitable approach). In another embodiment, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In yet other embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be a EBIF widget. In other embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing media, such as a non-portable gaming machine. For simplicity, these devices may be referred to herein collectively as user equipment or user equipment devices. User equipment devices, on which a media guidance application is implemented, may function as a standalone device or may be part of a network of devices. Various network configurations of devices may be implemented and are discussed in more detail below.

User television equipment 402 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated to be a single device, if desired. User computer equipment 404 may include a PC, a laptop, a tablet, a WebTV box, a personal computer television (PC/TV), a PC media server, a PC media center, or other user computer equipment. WEBTV is a trademark owned by Microsoft Corp. Wireless user communications device 406 may include PDAs, a mobile telephone, a portable video player, a portable music player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 402, user computer equipment 404, and wireless user communications device 406 may utilize at least some of the system features described above in connection with FIG. 3 and, as a result, include flexibility with respect to the type of media content available on the device. For example, user television equipment 402 may be Internet-enabled allowing for access to Internet content, while user computer equipment 404 may include a tuner allowing for access to television programming. The media guidance application may also have the same layout on the various different types of user equipment or may be tailored to the display capabilities of the user equipment. For example, on user computer equipment, the guidance application may be provided as a web site accessed by a web browser. In another example, the guidance application may be scaled down for wireless user communications devices.

In system 400, there is typically more than one of each type of user equipment device but only one of each is shown in FIG. 4 to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets).

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.tvguide.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile device (e.g., Blackberry) network, cable network, public switched telephone network, or other types of communications network or combinations of communications networks. BLACKBERRY is a service mark owned by Research In Motion Limited Corp. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes media content source 416 and media guidance data source 418 coupled to communications network 414 via communication paths 420 and 422, respectively. Paths 420 and 422 may include any of the communication paths described above in connection with paths 408, 410, and 412. Communications with the media content source 416 and media guidance data source 418 may be exchanged over one or more communications paths, but are shown as a single path in FIG. 4 to avoid overcomplicating the drawing. In addition, there may be more than one of each of media content source 416 and media guidance data source 418, but only one of each is shown in FIG. 4 to avoid overcomplicating the drawing. (The different types of each of these sources are discussed below.) If desired, media content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Media content source 416 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other media content providers. NBC is a trademark owned by the National Broadcasting Company, Inc., ABC is a trademark owned by the ABC, INC., and HBO is a trademark owned by the Home Box Office, Inc. Media content source 416 may be the originator of media content (e.g., a television broadcaster, a Webcast provider, etc.) or may not be the originator of media content (e.g., an on-demand media content provider, an Internet provider of video content of broadcast programs for downloading, etc.). Media content source 416 may include cable sources, satellite providers, on-demand providers, Internet providers, or other providers of media content. Media content source 416 may also include a remote media server used to store different types of media content (including video content selected by a user), in a location remote from any of the user equipment devices. Systems and methods for remote storage of media content, and providing remotely stored media content to user equipment are discussed in greater detail in connection with Ellis et al., U.S. patent application Ser. No. 09/332,244, filed Jun. 11, 1999, which is hereby incorporated by reference herein in its entirety.

Media guidance data source 418 may provide media guidance data, such as media listings, media-related information (e.g., broadcast times, broadcast channels, media titles, media descriptions, ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips, etc.), on-demand information, and any other type of guidance data that is helpful for a user to navigate among and locate desired media selections.

Media guidance application data may be provided to the user equipment devices using any suitable approach. In some embodiments, the guidance application may be a stand-alone interactive television program guide that receives program guide data via a data feed (e.g., a continuous feed, trickle feed, or data in the vertical blanking interval of a channel). Program schedule data and other guidance data may be provided to the user equipment on a television channel sideband, in the vertical blanking interval of a television channel, using an in-band digital signal, using an out-of-band digital signal, or by any other suitable data transmission technique. Program schedule data and other guidance data may be provided to user equipment on multiple analog or digital television channels. Program schedule data and other guidance data may be provided to the user equipment with any suitable frequency (e.g., continuously, daily, a user-specified period of time, a system-specified period of time, in response to a request from user equipment, etc.). In some approaches, guidance data from media guidance data source 418 may be provided to users' equipment using a client-server approach. For example, a guidance application client residing on the user's equipment may initiate sessions with source 418 to obtain guidance data when needed. Media guidance data source 418 may provide user equipment devices 402, 404, and 406 the media guidance application itself or software updates for the media guidance application.

Media guidance applications may be, for example, stand-alone applications implemented on user equipment devices. In other embodiments, media guidance applications may be client-server applications where only the client resides on the user equipment device. For example, media guidance applications may be implemented partially as a client application on control circuitry 304 of user equipment device 300 and partially on a remote server as a server application (e.g., media guidance data source 418). The guidance application displays may be generated by the media guidance data source 418 and transmitted to the user equipment devices. The media guidance data source 418 may also transmit data for storage on the user equipment, which then generates the guidance application displays based on instructions processed by control circuitry.

Media guidance system 400 is intended to illustrate a number of approaches, or network configurations, by which user equipment devices and sources of media content and guidance data may communicate with each other for the purpose of accessing media and providing media guidance. The present invention may be applied in any one or a subset of these approaches, or in a system employing other approaches for delivering media and providing media guidance. The following three approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit media content. For example, a user may transmit media content from user computer equipment to a portable video player or portable music player.

In a second approach, users may have multiple types of user equipment by which they access media content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. patent application Ser. No. 10/927,814, filed Aug. 26, 2004, which is hereby incorporated by reference herein in its entirety.

In a third approach, users of user equipment devices inside and outside a home can use their media guidance application to communicate directly with media content source 416 to access media content. Specifically, within a home, users of user television equipment 404 and user computer equipment 406 may access the media guidance application to navigate among and locate desirable media content. Users may also access the media guidance application outside of the home using wireless user communications devices 406 to navigate among and locate desirable media content.

It will be appreciated that while the discussion of media content has focused on video content, the principles of media guidance can be applied to other types of media content, such as music, images, etc.

In some embodiments, a user may utilize the media guidance application or other application to manage audio assets. For example, the audio assets may be part of a personal playlist, public playlist, internet radio, a web cast, a real-time stream or any other suitable source for audio assets. The term audio asset is defined herein as a binary representation of changes in air pressure through time to create sound. In certain embodiments, the audio assets may be digital audio assets. For the purpose of this invention, audio assets may include data in various formats such as: MP3, WAV, real-time audio broadcast, Dolby Stereo, Dolby Digital, Pulse Code Modulation (PCM), Audio Interchange File Format (AIFF), Adaptive Transform Acoustic Coding (ATRAC), Digital Theatre System (DTS), Sony Dynamic Digital Sound (SDDS), Windows Media Audio (WMA), The True Audio Lossless Codec (TTA), Free Lossless Audio Codec (FLAC), Advanced Audio Coding (AAC), Apple Lossless (ALAC), OggPCM or any other suitable audio format.

In particular, a user may control selection and playback of audio assets with user equipment 402, 404 or 406 or any other suitable user equipment. For example, a user may control audio assets from a personal playlist displayed on a television using a remote control. As another example, a user may control a real-time stream of an audio asset displayed on a computer screen using a qwerty keyboard, mouse or a combination of both. As yet another example, a user may control a sportscast on a wireless communications device using a keypad, touch screen, trackball or scroll wheel. The audio assets and control mechanisms in each of the previous examples may be combined or interchanged.

Data associated with the audio assets may be stored directly on the user equipment or may be provided remotely by media content source 416. In particular, an audio asset may be provided by the media content source, as a real-time stream of the audio asset, such as from an Internet source, or the audio asset may be accessed from a server in communication with the media content source. For example, a user may download a music file asset over the internet from a remote server to local storage 308 (FIG. 3). As another example, a user may stream a live sportscast from a sports content provider via communications network 414.

The media guidance application may be used to associate audio assets with related visual media content for display during playback of the audio asset to provide an engaging visual experience to a user in addition to the auditory experience provided by the audio asset. For example, when a user selects the song “White Wedding” by Billy Idol for playback, a YouTube video showing a clip from the video game Rock Band in which “White Wedding” is played, may be associated with the song and displayed during playback of “White Wedding”. The term visual media content is defined herein as any human perceivable content that has been electronically captured. Visual media content may include video content, video clips, movies, a movie scene, articles, advertisements, chat sessions, video games, television shows, music videos, pay-per-view programs, on-demand programs (as in video-on-demand (VOD) systems), Internet content (e.g., streaming media, downloadable media, Webcasts, etc.), album art, photos, and any other suitable type of visual media content known to those of skill in the art.

When a user selects an audio asset, or an audio asset is automatically selected from, for example, a playlist, a search may be performed to identify visual media content with meta-data related to meta-data associated with the selected audio asset. The search may be carried out by control circuitry 304 of user equipment device 300 (FIG. 3). For example, control circuitry 304 (FIG. 3) may search a source for title meta-data matching the title of a particular audio asset. For example, when the audio asset “Thriller” by Michael Jackson is selected for playback, a search by control circuitry 304 may result in finding that the title “Thriller” matches title meta-data for the music video for “Thriller”. As another example, the search may result in matching audio asset artist meta-data: “Michael Jackson” with artist meta-data corresponding to a video clip of Michael Jackson moonwalking. As another example, a search may be performed based on a date associated with the audio asset. A user may select an audio asset recorded in 1978 (e.g., “Lay Down Sally” by Eric Clapton). The control circuitry 304 may search a source and retrieve visual media content corresponding to sporting events taking place in 1978. For example, a video clip of the 1978 World Series between the New York Yankees and the Los Angeles Dodgers may be identified as a result of the search by control circuitry 304. The 1978 World Series visual media content may be associated with the audio asset “Lay Down Sally” by Eric Clapton and displayed during playback of “Lay Down Sally”. In certain embodiments, a user may define preferences for what results a search will return. For example, a user could specify that a search be performed based only on the title and artist of a particular audio asset.

The source which is searched for visual media content may be any type of source capable of providing visual media content such as: a database, Internet, a hard drive, a remote device, mobile device, a server or any other suitable source. The identified visual content may be associated with the audio asset and displayed on the user equipment during playback of the audio asset. In particular, visual content may be associated with an audio asset by creating a hotlink, tag, identifier, by transferring one or both of the visual content and audio asset to a database, or any other suitable association method. For example, when visual media content, (e.g., a television show), is found to include a particular audio asset, a link to the server where the television show can be downloaded may be saved as meta-data linked to the audio asset. As another example, when visual media content, for example, a movie clip, is found to include a particular audio asset, the movie clip may be saved to a database with an identifier indicating that the movie clip is related to the particular audio asset. In yet another example, when visual media content is identified, the visual media content may be saved to a hard drive in a directory or folder related to the audio asset.

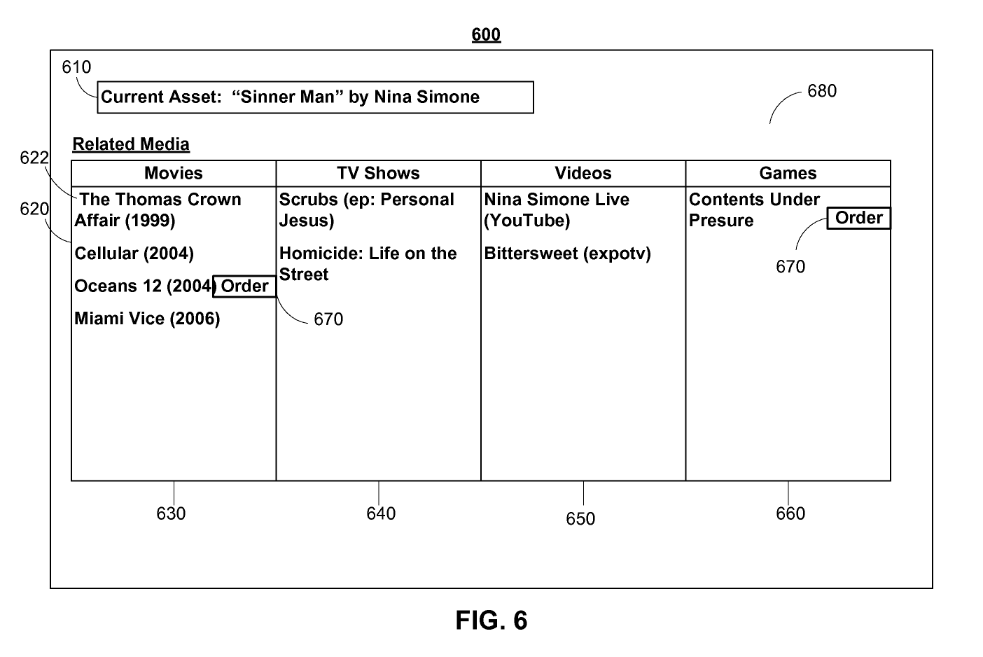

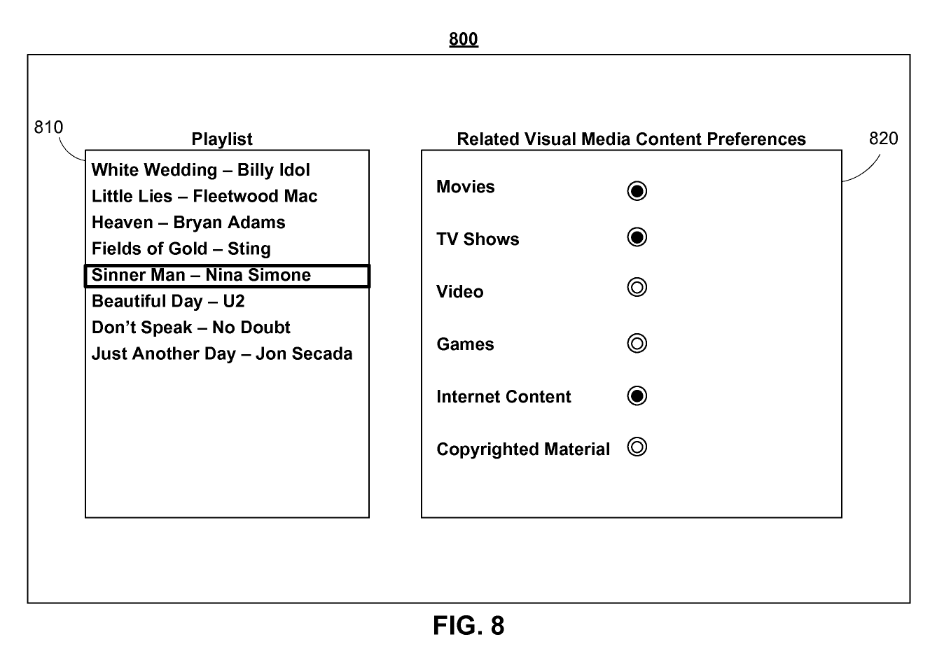

FIG. 5 is an illustrative display of a playlist menu screen 500 in accordance with another embodiment of the invention. Screen 500 may include playlist 510, audio asset 512, playback controls 520 and display area 530. Screen 500 may include an advertisement 540 which may have similar functionality as advertisement 124 (FIG. 1). For brevity, the discussion of advertisement 540 functionality is omitted but should be understood to encompass the same or similar functionality as advertisement 124 (FIG. 1). The display area 530 is illustrated in FIG. 5 as a partial screen display, however the display area may cover the entire screen (as described below with respect to FIG. 7), or may include multiple screen areas.

Playlist 510 may include a listing of audio assets such a music, podcasts, Internet content, real-time feeds, or any other suitable audio assets. Playlist 510 may include a combination of many different types of audio assets. For example, playlist 510 may include a music track, followed by a webcast of a local high school basketball game, followed by a recording of the President's State of the Union Address. A user may use playlist 510 to sort, organize and rank the various audio assets in the playlist. For example, a user may organize music tracks in a first folder, and audio books in a second folder. Moreover, the user may rank the audio assets based on various criteria such as: playback preference, order of desired playback, playback frequency or any other suitable ranking criteria. Playlist 510 may provide advanced options such as shuffle mode, automatic playback, or playback based on the most likely next audio asset to be selected by a user. For example, when a user selects an audio asset by recording artist Bon Jovi, playlist 510 may automatically select another audio asset recorded by Bon Jovi to be played back next. Additionally, playlist 510 may create a medley of Bon Jovi songs, in which part or all of the songs in the medley may be played back. Play lists and their functionalities are described in greater detail in U.S. Patent Application Publication No. 2008/0115173, filed Nov. 10, 2006 and U.S. Patent Application Publication No. 2008/0114794, filed Nov. 10, 2006 which are hereby incorporated by reference herein in their entireties.

A user may select an audio asset from playlist 510. In particular, a user may select an audio asset by clicking it with a mouse, by navigating a cursor over the audio asset and pressing an ‘enter’, ‘select’, or ‘OK’ button, by touching the audio asset on a touch screen, or any other suitable method for selecting an audio asset. As depicted in FIG. 5, audio asset 512 “Sinner Man—Nin Simone” is highlighted. In response to a user selection of an audio asset, visual media content may be automatically displayed in display area 530. For example, when a user selects “Sinner Man—Nina Simone” for playback, a movie clip from the movie “Cellular (2004)” which includes the song “Sinner Man” by Nina Simone may be displayed in display area 530. Selection of an audio asset and control of playlist menu 500 may be executed by using, for example, user equipment such as user equipment 402, 404 or 406 (FIG. 4). In certain embodiments, a prompt may be displayed in response to a user selection of a particular audio asset. In particular, the prompt may provide or request information from the user. For example, after a user selects an audio asset for which no visual media content is identified during a search, a prompt may be displayed indicating that no visual media content was found. Additionally, the prompt may request whether the user would like to associate content with the particular asset and/or upload media content. In certain embodiments, a user may hand select visual media content to associate with a particular asset. For example, a user may upload a montage of family photos to be associated with and displayed during playback of a particular audio asset.

In certain embodiments, a prompt may be displayed indicating when visual media content has already been displayed during playback of a particular audio asset. For example, when a user selects particular visual media content, or visual media content is automatically selected to be displayed with a particular audio asset, and that visual media content has previously been displayed, a prompt may notify the user that the visual media content has already been viewed and may request if the user would like to select different visual media content to be displayed. In certain embodiments, a history of visual media content displayed for a particular audio asset may be stored on storage 308 of control circuitry 304. In particular, the visual media content history data may be used be by control circuitry 304 to improve media guidance function. For example, the visual media content history data may be used to indicate to a user what media has been played, to create favorites lists, to determine other visual media content of audio assets that a user make like, or any other suitable uses for the history data.

In certain embodiments, the audio asset may be automatically selected by processing circuitry 306. For example, playlist 510 may be configured to continue to the next audio asset in the list after the previous audio asset has finished. For example, after “Fields of Gold—Sting” has finished playback, audio asset 512 “Sinner Man—Nina Simone” may be automatically selected for playback. In certain embodiments, the automatic playback may not commence in the order set out in the playlist, but rather in a random fashion.

Playback controls 520 may be used to control playback of the selected audio asset or also may be used to navigate through the playlist 510. Playback controls 520 may also be used to control visual media content displayed in display area 530, or separate controls may be provided for controlling the visual media content.

In certain embodiments, mechanisms other than a playlist, such as playlist 510, may be used to access and control audio assets. For example, an audio asset may be selected and controlled from an Internet browser or directly from a Media Guidance Application. As another example, a radio station (e.g., Internet radio) may automatically provide songs, for example by a DJ or radio software. In this example, selection and playback control may be done by a user, by the radio station or a combination of both.

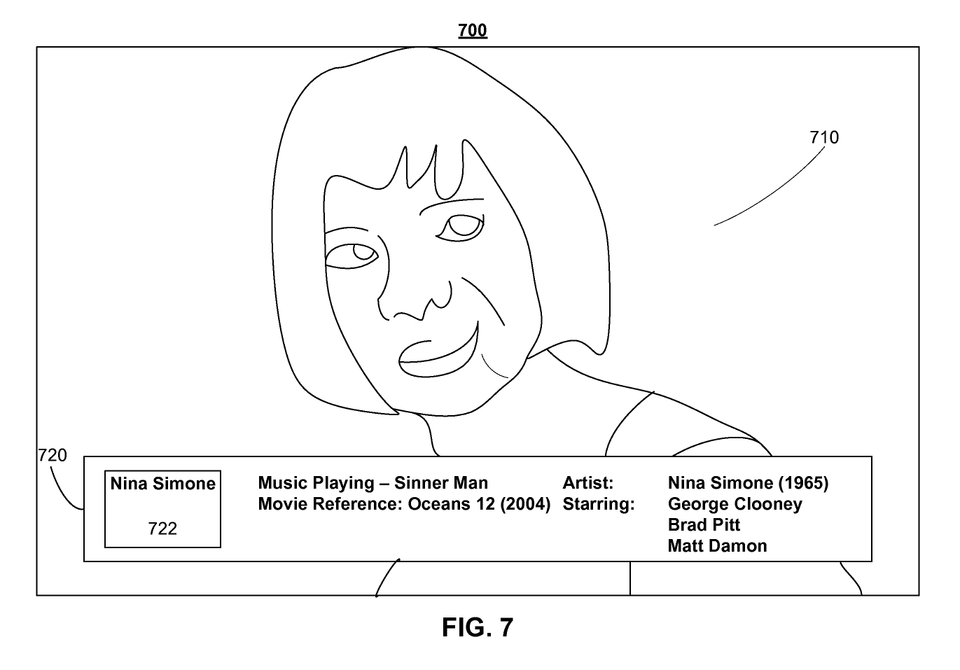

In some embodiments, when an audio asset is selected, a prompt or menu may be optionally displayed indicating visual media content that includes at least a portion of the audio asset. FIG. 6 is an illustrative display of a related media menu screen 600 in accordance with another embodiment of the invention. In particular, selection of audio asset 512 (FIG. 5) may navigate the user to (or cause the display of) related media menu screen 600. For example, after a user selects an audio asset, related media menu screen 600 may appear as a prompt, requesting a user to select visual media content for display. In another example, related media menu screen 600 may be displayed as a window adjacent a user play list, and may be automatically updated with visual media content each time a user scrolls to, or selects an audio asset. Related media menu screen 600 may include current asset information region 610, related media region 620, visual media content 622, related media content columns 630, 640, 650, 660, and user order option regions 670.

In certain embodiments, related media region 620 may be overlaid on top of visual media content 680 being displayed in the background of screen 600. For example, when a user is viewing visual media content, related media screen 620 may appear as an overlay (e.g., transparent overlay) allowing a user to simultaneously watch visual media content 680 and browse the contents of related media region 620.

Current asset information region 610 may provide information associated with the current selected asset. For example current asset information region 610 may display asset title, artist, year, run length, or any other information related to the current asset. In FIG. 6, the current asset information region displays the title (“Sinner Man” ) and artist (“Nina Simone”) of the audio asset 512 selected from screen 500 (FIG. 5).

When a user navigates to related media menu screen 600, control circuitry 304 (FIG. 3) may retrieve from memory (locally or remotely) a list of related visual media content which includes at least a portion of the selected audio asset. For example, control circuitry may access a database from storage 308 (FIG. 3) containing visual media content related to a selected audio asset, identified during a search. Control circuitry 304 may determine that visual media content includes at least a portion of the particular audio asset by reading identifiers associated with the visual media content, by identifying particular meta-data associated with the visual media content, or by any other suitable method for retrieving visual media content.

Related media region 620 may display the visual media content that is related to the selected audio asset. For example, “The Thomas Crown Affair (1999)” is located in listing 622. The related visual media content may be selected by a user for display, or in certain embodiments, the order in which visual media content will be displayed during audio asset playback may be presented to the user.

Related media region 620 is grouped into four content columns in the example of FIG. 6: “Movies” 630, “TV shows” 640, “Videos” 650 and “Games” 660. Although FIG. 6 depicts four content columns, there may any number of content columns depending on user preferences and/or what types of visual media content is available in certain embodiments. In certain embodiments, content producers may purchase rights to display advertisements or other content in media region 620. For example, a video game company may purchase rights to place new video game content in “Games” column 660. In some embodiments, the advertisements displayed in media region 620 may be related to the type of audio asset selected, and/or visual media content displayed.

In certain embodiments order option region 670 may appear next to visual media content in related media region 620. For example, order option region 670 appears next to “Oceans 12 (2004)” in “Movies” content column 630, and next to “Contents Under Pressure” in “Games” content column 660. The order option region 670 may indicate to a user that a particular visual medium must be purchased prior to display. In certain embodiments order option regions 670 may provide a link which can be selected to display purchase information. In certain embodiments, selection of order option region 670 may cause the display of a prompt providing information to a user or requesting information from the user. For example, when a user selects order option region 670 next to the visual media content “Contents Under Pressure” in games column 660, a prompt may be displayed requesting a user password or requiring billing information from the user for purchasing “Contents Under Pressure”. In certain embodiments, a prompt may be displayed indicating the price of a particular visual media asset, and asking permission to charge a user-account to download or stream the particular visual media asset. When a user provides valid permission, control circuitry 304 may transmit information identifying the visual media content over communications network 414 to a remote server. The remote server, or a third party service, may bill the user and allow the visual media content to be downloaded or streamed. In certain embodiment, a third party service may transmit an invoice or bill to the user equipment 402, 404 or 406, and allow the user to pay for the visual media content after the visual media content has been accessed.

Related media region 620 and current asset information region 610 may be part of a separate menu (as illustrated in FIG. 6) or may be overlays on top of visual media content in the background. In certain embodiments, regions 610 and 620 may be transparent so that visual media content in the background is visible behind the regions.

In some embodiments, selection of an audio asset may not navigate the user to (or cause the display of) related media menu screen 600. The related media 620 presented by the related media menu screen 600 may remain in a database and may not be displayed to the user. In particular, when a user selects a particular audio asset, visual media content may be automatically displayed during playback of the audio asset without displaying related media menu screen 600. For example, control circuitry 304 may automatically choose visual media content from a database, without user input, to be displayed during playback.

Although the example shown in FIG. 5 displays visual media content in a separate window alongside a play list, visual media content may be displayed simultaneously with an audio asset in various different layouts. For example, FIG. 7 is an illustrative display of a visual media content display screen 700 according to another embodiment of the invention. Display screen 700 may include visual media content 710, and audio asset information region 720. Audio asset information region 720 may include album art in window 722 related to the selected audio asset, as well as other information related to the audio asset and visual media content such as: title of the audio asset, title of related visual media content, artist name, actors' names, time remaining in audio asset, time remaining in the visual media content or any other suitable information. In certain embodiments window 722 may provide a picture-in-picture (PIP) display. In particular, window 722 may display visual media content other than content 710 related to an audio asset during playback of the audio asset. For example, referring back to FIG. 6, a scene from “Miami Vice (2006)” may be displayed in window 722 while “Oceans 12 (2004)” is displayed in the background 710. In certain embodiments there may be one or more windows 722, each displaying different visual media content.

Referring back to FIGS. 5 and 6, if a user selects audio asset 512 “Sinner Man—Nina Simone” (FIG. 5) and related visual media content “Oceans 12 (2004)” from the “Movies” content column 630 (FIG. 6), then one or more scenes from “Oceans 12 (2004)”, in which audio asset 512 “Sinner Man” is played, may be displayed as visual media content 710 during playback of “Sinner Man—Nina Simone”. For any particular audio asset, the visual media content to be played back may be selected by a user, by control circuitry 304, or by a third party. For example, a user may set user preferences to always display “Nina Simone Live (Youtube)” when the audio asset “Sinner Man—Nina Simone” is selected for playback. As another example, control circuitry 304 may automatically display visual media content from the “TV shows” column 640 (e.g., in the order listed or any particular order) in response to playback of audio asset “Sinner Man—Nina Simone”. As yet another example, visual media content may automatically displayed with a particular audio asset as specified by a third party. For example, an Internet blog or recommendation site may suggest a list of visual media content that suits an audio asset particularly well. Control circuitry 304 may display visual media content from the list suggested by the third party during playback of the audio asset.

Audio asset information region 720 may be displayed as an overlay with the visual media content in the background, as a separate window, as a transparent banner, or in any other suitable display method. Additionally, information region 720 may disappear from display after a certain amount of time, or may be dismissed by user input.

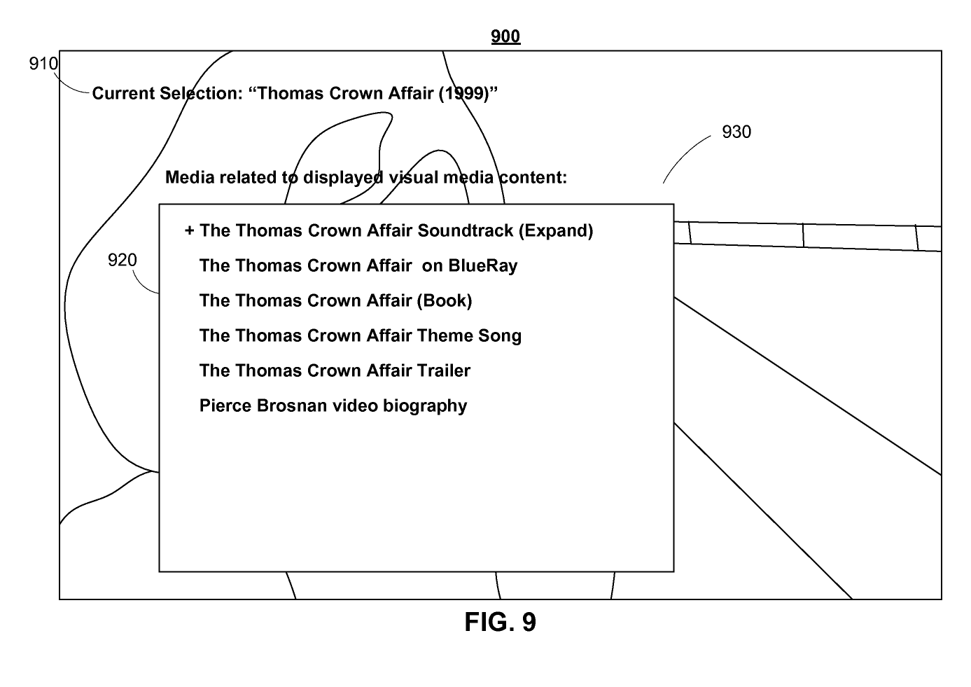

Referring back to FIG. 5, selection of audio asset 512 may navigate the user to (or cause the display of) screen 800 (FIG. 8). In certain embodiments, the user may navigate to screen 800 without selection of an audio asset. In particular, the user may use screen 800 to specify which type visual media content should be displayed during playback of an audio asset. For example, screen 800 may have radio buttons, check boxes, or any other suitable selection mechanism for allowing a user to specify visual media content. For example, the user may select the options to have only movies, television shows, and Internet content displayed during playback of an audio asset by clicking the radio buttons corresponding to movies, television shows, and Internet content with a mouse (FIG. 8). As another example, a user may remove undesired visual media content from specification menu 800 by highlighting the visual media content and pressing “delete” on a remote, a keyboard or any other suitable input device. In certain embodiments, the options selected by the user in screen 800 restrict the search of the source to the type of visual media content specified by the user. In particular, a user may access screen 800 in order to set preferences for searching for visual media content. For example, when a user only selects the radio button corresponding to “Internet Content”, then a search for visual media content which includes at least a portion of a selected audio asset may be confined to only Internet content.

Content specification menu 800 (FIG. 8) may include playlist 810 and related visual media content preference screen 820. At preference screen 820, a user can select the specific content to be displayed using user equipment. In certain embodiments, related visual media content preference screen 820 may display to a user what types of visual media content are available for a particular audio asset, and allow a user to select from the available options. For example, when “Sinner Man—Nina Simone” is highlighted, preference screen 820 may indicated that “Movies”, “TV Shows”, “Video”, “Games”, “Internet Content” and “Copyrighted Material” are all available for display. However, when “Don't Speak—No Doubt” is highlighted only “TV Shows” and “Internet Content” may be available as options in the preference screen 820.

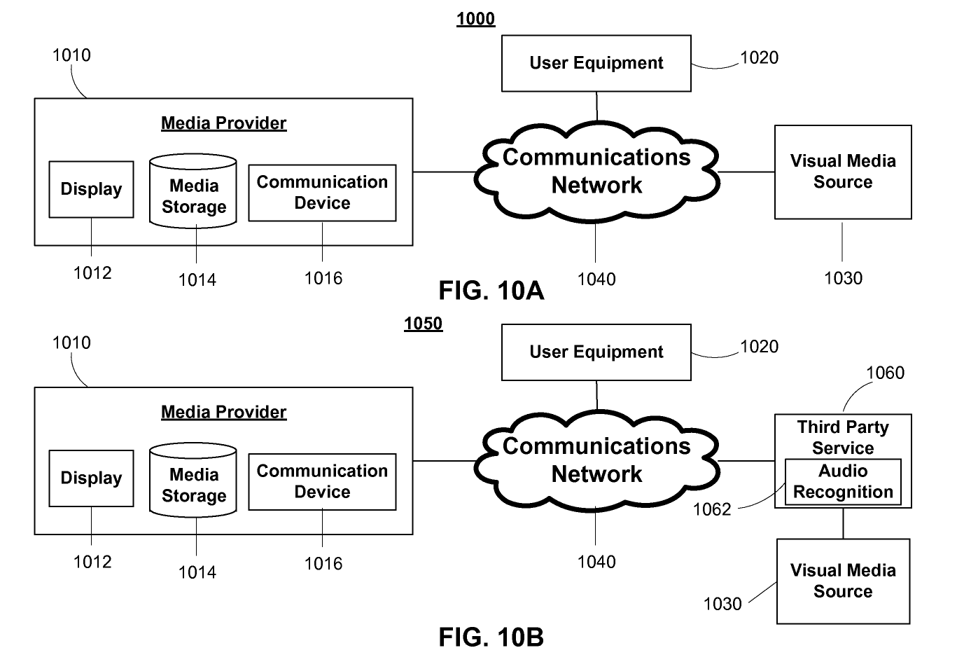

Referring back to FIG. 6, selection of visual media content 622 may navigate the user to (or cause the display of) screen 900 (FIG. 9). In particular, screen 900 displays a plurality of media assets related to the selected visual media content 622. For example, when a user selects visual media content “The Thomas Crown Affair (1999)” from content column 630 (FIG. 6), user equipment 402, 404 or 406 may navigate the user to screen 900 (or display options of screen 900 as an overlay). User equipment may identify and retrieve from memory (locally or remotely) a plurality of media assets related to “The Thomas Crown Affair (1999)”, such as “The Thomas Crown Affair Soundtrack”, and display identifiers representing each of the plurality of media assets in screen 900. The display of media assets related to visual media content in Screen 900 allows a user to be introduced to additional media assets (different from the visual media content) which they will most likely enjoy. Media assets displayed by screen 900 may be audio assets, visual media assets, Internet content, or any other suitable type of media asset.

Related media asset menu 900 includes current selection information 910, related media asset display screen 920 and visual media content 930. The media displayed in related media asset menu 900 may be any type of media, including audio media, visual media, textual media and any other type of media known to those of skill in the art. Media assets identifiers in display screen 920 may be displayed as a list or as selectable options. When a user selects a media asset identifier in the related media asset display screen 920 the media asset itself may be displayed, or information associated with the media asset may be displayed. In particular, when a media asset is selected, a link to purchase the media asset, a preview of the media asset, or any other suitable information associated with the media asset may be displayed. For example, selection of “Pierce Brosnan video biography” may provide a 15-second preview of the media content followed by a prompt asking if a user would like to download the entire content. Additionally, order buttons (e.g., order buttons 670) may displayed and function similarly as to described above with respect to FIG. 6.

Related media asset display screen 920 may be displayed as an overlay with the visual media content 930 in the background, as a separate window, as a transparent banner, or in any other suitable display method. Additionally, related media asset display screen 920 may disappear from display after a certain amount of time, or may be dismissed by user input.

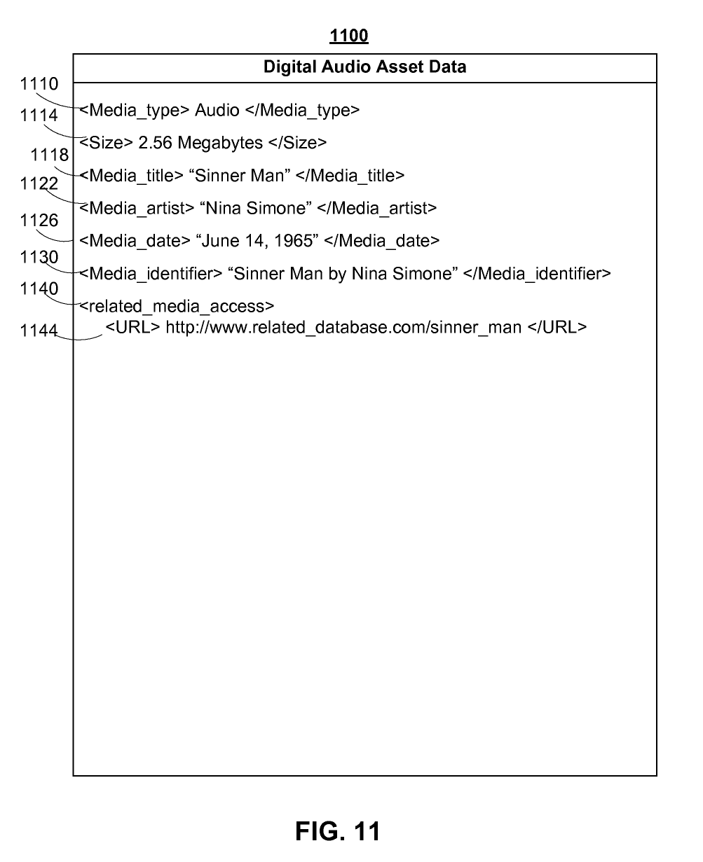

FIGS. 10A and 10B show systems 1000 (FIG. 10A) and 1050 (FIG. 10B) for associating music and visual media content in accordance with embodiments of the invention. System 1000 may include a media provider 1010, user equipment 1020, and a visual media source 1030 which are all interconnected by a communications network 1040. Media provider 1010 may include a display 1012, media storage 1014, and communications device 1016. For brevity, the discussion of user equipment 1020 functionality is omitted but should be understood to encompass the same or similar functionality as user equipment 402, 404 or 406 (FIG. 4). Similarly, communications network 1040 may be implemented as communications network 414 (FIG. 4). Also, media provider 1010 may be implemented as either or both media content source 416 or media guidance data source 418 (FIG. 4). Each of the components shown in FIGS. 10A and 10B may communicate with each other over communications network 1040 (e.g. short-range or long-range communications). In certain embodiments, any one of media provider 1010, user equipment 1020 and visual media source 1030 may be implemented on the same device.

A user may use user equipment 1020 to select an audio asset for playback. For example, the user may access screen 500 (FIG. 5) and select an audio asset from the playlist. User equipment 1020 may request the audio asset and meta-data associated with the audio asset from media provider 1010 or from internal storage within the user equipment, such as storage 308 (FIG. 3). For example, control circuitry may retrieve audio asset data from a data structure stored on storage 308 (FIG. 3) or it may send a request upstream with an identifier for audio asset data. When user equipment 1020 sends a request for data to the media provider 1010, the media provider may retrieve the data from media storage 1014 or it may communicate with, and retrieve the data from, visual media source 1030 through communications network 1040 or a combination of both. A similar process may be used to service a request by the user equipment for visual media content or related media asset data. For example, the related media content displayed in screen 600 (FIG. 6) may be displayed as a result of a search by the user equipment 1020 or media provider 1010 for visual media content that includes at least a portion of the audio asset. When an audio asset is selected, visual media source 1030 may be searched for visual media content that includes at least a portion the selected audio asset. Visual media source 1030 may be a database, Internet, a hard drive, remote device, mobile device, a server or any other suitable source.

When user equipment 1020 requests data from media provider 1010 or visual media source 1030, the data may be transferred from the media provider 1010 or media source 1030 to the internal storage 308 within the user equipment 1020, or the data may be streamed directly from the media provider 1010 or the media source 1030 over communications network 1040.

In addition to the components of system 1000, System 1050 includes a third party service 1060 connected between the communications network 1040 and the visual media source 1030. The third party service 1060 may include an audio recognition apparatus 1062. In particular, the user equipment 1020 may send a request for data directly to a third party service 1060. The third party service may communicate with media provider 1010 and visual media source 1030 to search for and retrieve data, as well as associate visual media content with a selected audio asset. For example, user equipment 1020 may send a request to retrieve visual media content that includes at least a portion of a particular audio asset to the third party service 1060. The third party service 1060 may search the visual media source 1030 to find visual media content related to the audio asset and associate that visual media content with the audio asset.

In certain embodiments, the media provider 1010 communicates with the third party service 1060 to retrieve data before transferring it to the user equipment 1020. For example, the media provider 1010 may provide audio asset data to the third party service 1060 with a request for related visual content. The third party service may search and associate related visual media content with the audio asset and transfer the data back to the media provider 1010 or to the user equipment 1020.

Third party service 1060 includes audio recognition apparatus 1062 for executing an audio recognition process. The audio recognition process employed by the third party service 1060 may cross-reference audio frequency data associated with the audio asset with audio frequency data associated with visual media content. The third party service 1060 may use the audio recognition process when searching for and associating visual media content with an audio asset. For example, if audio data for audio asset 512 “Sinner Man” (FIG. 5) is transferred to the third party service 1060, the third party service may use the audio recognition process to determine that the transferred audio data corresponds to the audio asset “Sinner Man”, and that “The Thomas Crown Affair” also includes similar or the same audio data. The third party service 1060 can then associate the entire movie “The Thomas Crown Affair” or one or more particular scenes with the “Sinner Man” audio asset.

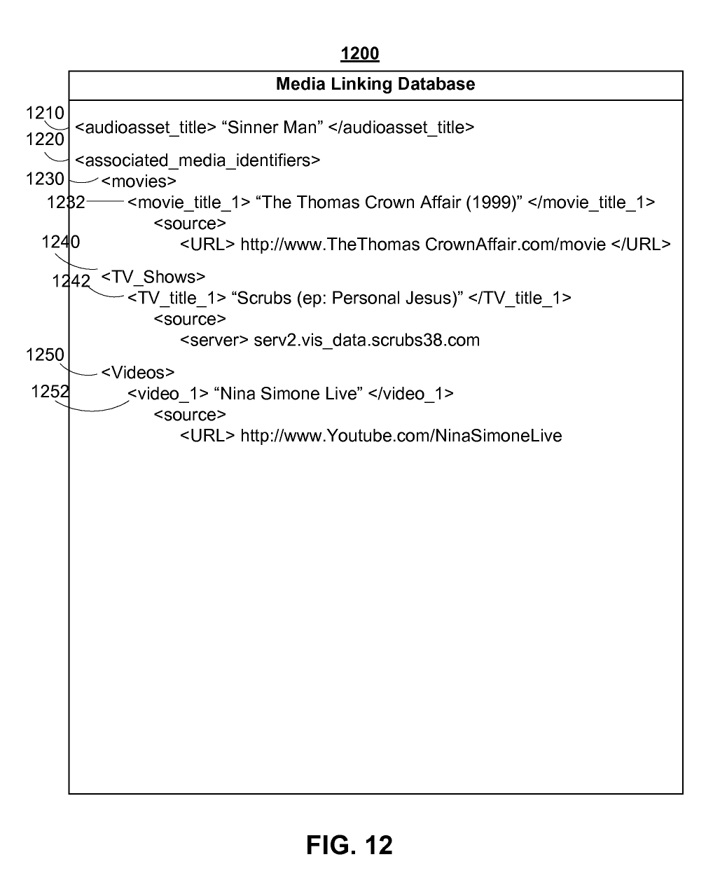

The data associated with the audio asset may be a data structure that includes various fields that identify the audio asset or provide criteria for associating visual media content. The data associated with the audio asset may be of the type shown in FIG. 11. In particular, FIG. 11 shows an exemplary data structure 1100 for an audio asset in accordance with an embodiment of the present invention.

Data structure 1100 may include a media type field 1110, a media asset size field 1114, a media title field 1118, a media artist field 1122, a media date field 1126, a media identifier field 1130, a related media access field 1140 and URL link 1144. Media type field 1110 and Size field 1114 may be used by processing circuitry 306 (FIG. 3) to organize and store an audio asset and its related data. Media identifier field 1130 may be used by the user equipment 1020 to display audio asset identification information to a user, for example as the asset title and artist 5212 of playlist 510 (FIG.5). Related media access field 1140 may be used by the user equipment 1020, media provider 1010 and/or third party service 1060 to locate and retrieve audio asset data. For example, data structure 1100 contains a URL link 1144 in the related media access field 1140 indicating where the audio asset is located.

Media title field 1118, media artist field 1122 and media date field 1126 may be displayed to the user, for example in any of the screens of FIGS. 5-9, and may be used to determine related visual media content that includes at least a portion of the audio asset. In particular, data associated with the audio asset, such as media title, media artist, media date or any other suitable data, may be compared to and associated with data related to visual media content. For example, media provider 1010 may search visual media source 1030 for data associated with visual media content that matches media artist field 1122 “Nina Simone” from audio asset display structure 1100. When visual media content which also includes data corresponding to artist “Nina Simone” is identified, the visual media content may be entered into a media associating database stored on the media storage 1014 of media provider 1010, or on storage 308 of user equipment 1020.

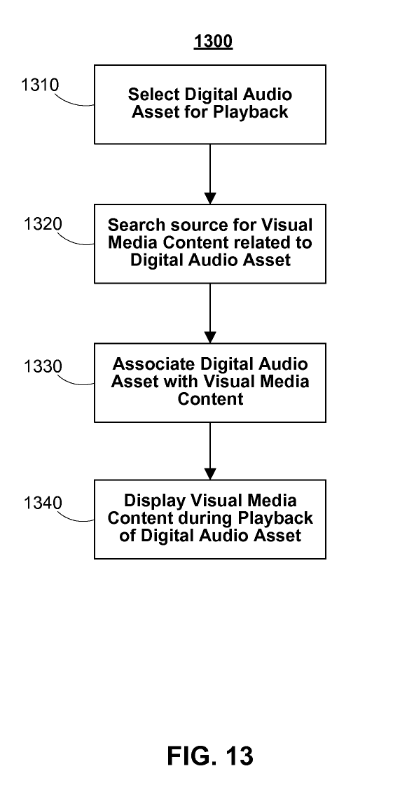

The data associated with the media associating database may be a data structure that includes various fields that identify related visual media content or provide criteria for associating visual media content with audio assets. The data stored in the media associating database may be of the type shown in FIG. 12. In particular, FIG. 12 shows an exemplary data structure 1200 for a media associating database in accordance with an embodiment of the present invention.

Data structure 1200 may include audio asset title field 1210, associated media identifier field 1220, movies field 1230, movie title 1 field 1232, TV shows field 1240, TV title 1 field 1242, videos field 1250, and video 1 filed 1252. Audio asset title field 1210 may be used by processing circuitry 306 to determine the audio asset that the database is linked with. For example, processing circuitry may read audio asset title 1210 to determine that data structure 1200 is linked to the “Sinner Man” audio asset. In certain embodiments, other data may be used to identify the audio asset associated with a particular data structure, such as audio frequency data, storage location or any other suitable type of data.

Associated media identifiers field 1220 may indicate data associated visual media content related to the audio asset. In particular, the associated media identifiers 1220 may include a movies field 1230 and TV shows field 1240, a videos field 1250 or any other field suitable for the visual media content type. Referring back to FIG. 6, each column 630, 640, 650 and 660 may correspond to an associated media identifier in data structure 1200. For example, movie_title_1 1232 “The Thomas Crown Affair (1999)” may be identified in data structure 1200 by processing circuitry 306 and displayed in content column 630 of screen 600 (FIG. 6). Additionally, data structure 1200 may include the source of the related media content. For example, a URL is included for movie_title_1 1232 which indicates where “The Thomas Crown Affair (1999)” may be located. The source of the visual media content may be a URL, a server, a hard drive or any other suitable storage location.

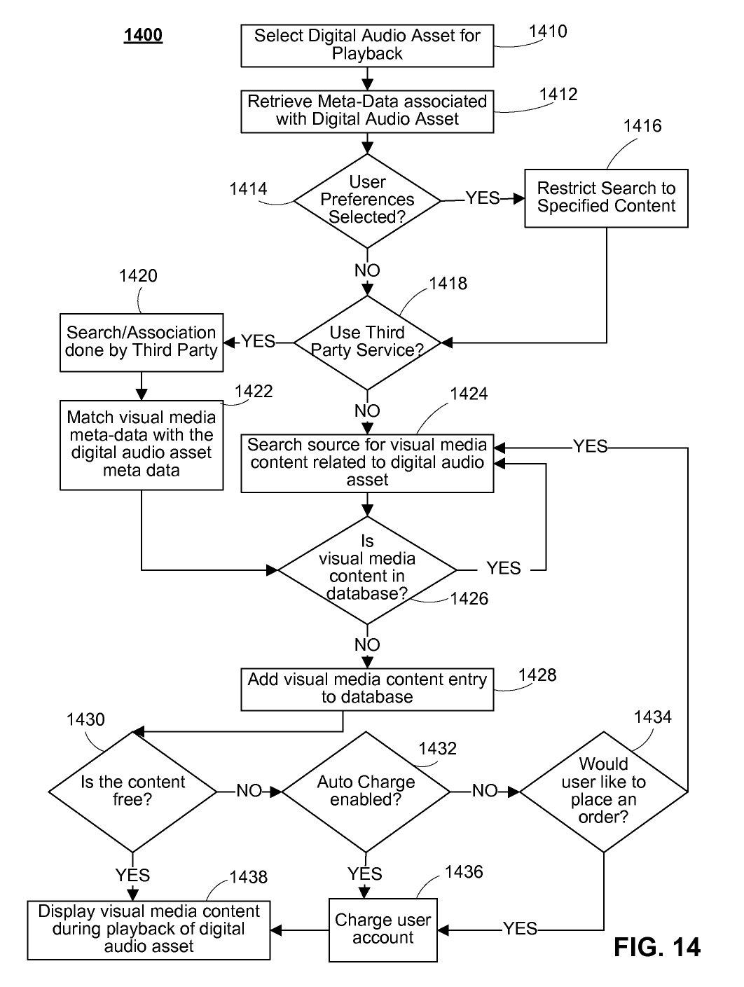

FIG. 13 is an illustrative flow diagram 1300 for associating audio assets and visual media content in accordance with another embodiment of the present invention. At step 1310 an audio asset is selected for playback. For example, a user may use user equipment 402, 404 or 406 to access a playlist menu screen 500 to view and select an audio asset from a playlist. In certain embodiments, no user input is involved and the audio asset is selected automatically, for example, by processing circuitry 306. The audio asset may be automatically selected as the next entry in a continuous playlist. The selected audio asset may be played back in response to user selection, automatic selection, or in response to any of steps 1310, 1320, 1330 or 1340.

At step 1320, a source is searched for visual media content related to the audio asset selected by the user. In particular, the source is searched for visual media content that includes at least a portion of the audio asset selected by the user. For example, user equipment device 1020 may search visual media source 1030 for one or a plurality of visual media content which includes at least a portion of the selected audio asset. The search may include retrieving meta-data associated with the selected audio asset. For example, user equipment 1020 may retrieve meta-data associated with a selected audio asset from internal storage 308 and/or from media provider 1010 before searching visual media source 1030. In particular, the search for related visual media content may be performed based on retrieved meta-data associated with the audio asset.

In certain embodiments storage on user equipment 1020, such as storage 308 (FIG. 3), or media storage 1014 of media provider 1010 may be the source (or sources) searched for visual media content related to the audio asset. In certain embodiments, search step 1320 is repeated each time an audio asset is selected for playback.

In step 1330, the audio asset is associated with visual media content identified in step 1320. In particular, when at least a portion of visual media content is found to include at least a portion of the audio asset (e.g. has corresponding meta-data) the audio asset is associated with one of the plurality of identified visual media content. The association step may include adding an entry associated with the audio asset to a database and an identifier for the visual media content that is linked to the entry. In certain embodiments, the searching of step 1320 and the associating of step 1330 may occur continuously as the audio asset is being played back. For example, when a user selects audio asset 512 (FIG. 5), the audio asset may be played back and related visual media content may be displayed on screen 530 while the search step 1320 and association step 1330 are in progress. In addition, the searching step 1320 may be repeated each time an audio asset is selected. This ensures that any new visual media content not previously associated with an audio asset is associated with the audio asset each time it is selected.

The searching step 1320 and associating step 1330 may be performed by control circuitry 304 of user equipment 1020. In situations where a request is sent by user equipment 1020 to third party service 1060, the third party service may perform the searching and associating steps. For example, the third party service 1060 may search for visual media content meta-data and compare the visual media content meta-data with audio asset meta-data sent from the user equipment 1020 or the media provider 1010. The third party service 1060 may match the visual media content with the audio asset based on, at least in part, the compared meta-data of each.

In step 1340, the visual media content is displayed during playback of the audio asset. For example, if movie clip is associated with the audio asset in step 1330, it may be displayed, for example in display area 530 (FIG. 5), during playback of the audio asset.

In practice, one or more steps shown in process 1300 may be combined with other steps, performed in any suitable order, performed in parallel (e.g., simultaneously or substantially simultaneously), or removed.

FIG. 14 is an illustrative flow diagram 1400 for associating audio assets and visual media content in accordance with another embodiment of the present invention. At step 1410 an audio asset is selected for playback. For example, a user may use user equipment 402, 404 or 406 to access a playlist menu screen 500 to view and select an audio asset from a playlist. In certain embodiments, an audio asset is selected automatically (i.e., without user input), for example, by control circuitry 304. The audio asset may be automatically selected as the next entry in a continuous playlist.

At step 1412, meta-data associated with the audio asset is retrieved. For example, the meta-data associated with the audio asset may be stored in a data structure, such as data structure 1100 (FIG. 11). The data structure may be stored on the user equipment 1020 or may be provided by media provider 1010.

At step 1414, a determination is made as to whether the user has selected any preferences. For example, the user may input content preferences using screen 820 of the content specification menu 800 (FIG. 8). If a user indicates certain content display preferences, the search for visual media content is restricted to the user specified content, as in step 1416. In certain embodiments, if no user preferences are selected, the search remains open to all types of visual media content.

In step 1418, a determination is made as to whether to utilize a third party service. For example, meta-data associated with the audio asset may be transferred to a third party service, such as third party service 1060, using communications network 1040 (FIG. 10B). In step 1420, the third party may utilize the meta-data associated with the audio asset to perform a search for related visual media content and associate related visual media content with the audio asset. The search and associations steps performed by the third party service may be the same or similar to steps 1320 and 1330 as described above (FIG. 13).

In step 1422, the third party service may match visual media content meta-data with the audio asset meta-data. In certain embodiments, the audio media asset meta-data includes the audio media asset itself. As discussed above, the third party service may use an audio recognition apparatus to identify the audio asset and associate visual media content with the audio asset.

If a third party service is not available or not required, a search of a source is performed for visual media content which includes at least a portion of the audio asset in step 1424. For example, a visual media source, such as visual media source 1030 (FIG. 10A) may be searched by control circuitry 304 for visual media content that includes at least a portion of the audio asset. Some examples of visual media content that include at least a portion of an audio asset may be a movie in which the audio asset was played, a music video featuring the audio asset, a television show featuring the audio asset or any other suitable visual media content which may include the audio asset.

In step 1426, a determination is made as to whether the visual media content identified in step 1424 is currently in a database, such as database 1200, related to the audio asset. If the visual media content is already associated with the audio asset and already placed in the database, the search is continued for new visual media content to add to the database.

If the identified visual media content has not yet been added to the database related to the audio asset, it is added in step 1428. In step 1430, a determination is made as to whether the visual media content is free of charge. For example, the visual media content may hold a copyright and may cost $2.99 to view. If the visual media content requires a fee before viewing, a determination must be made as to whether an auto-charge option is available in step 1432. For example, the user may specify, using user equipment 1020, that all charges for visual media content be automatically charged to a user account without notifying or inconveniencing the user (Step 1436).

However, in certain embodiments the user may wish to be notified before a charge is made to their account. In step 1434, a determination is made whether a user would like to place an order for visual media content that requires a fee. For example, as illustrated in FIG. 6, an order button 670 may be used to provide an option to the user to purchase the visual media content.

In step 1438, visual media content associated with the audio asset is displayed during playback of the audio asset. For example, the visual media content may be displayed in display area 530 (FIG. 5) or as visual content 710 in the full screen depiction of FIG. 7 during playback of the audio asset.

In practice, one or more steps shown in process 1400 may be combined with other steps, performed in any suitable order, performed in parallel (e.g., simultaneously or substantially simultaneously), or removed.

The above described embodiments of the present invention are presented for purposes of illustration and not of limitation, and the present invention is limited only by the claims which follow.

What is claimed is:

1. A method for associating audio assets and visual media comprising:
selecting an audio asset for playback;
in response to selecting the digital audio asset for playback, searching a source to identify visual media content which includes at least a portion of the selected audio asset;
associating the audio asset with the identified visual media content; and
displaying the visual media content associated with the audio asset during playback of the audio asset.

2. The method of claim 1, wherein the searching further comprises retrieving meta-data associated with the audio asset, and wherein the search is performed based on the retrieved meta-data.

3. The method of claim 2, wherein the meta-data associated with the audio asset is selected from the group consisting of: a title of the audio asset, artist name associated with the audio asset, and a date associated with the audio asset.

4. The method of claim 1, wherein:
the searching comprises searching to identify a plurality of visual media content; and
the associating the audio asset comprises linking the audio asset with one of the plurality of visual media content.

5. The method of claim 1, wherein the associating further comprises adding an entry associated with the audio asset and an identifier for the identified visual media content that is linked to the entry to a database.

6. The method of claim 1, wherein the searching and the associating are performed continuously as the audio asset is being played back.

7. The method of claim 1, further comprising: repeating the searching every time the audio asset is selected for playback.

8. The method of claim 1, wherein the source is selected from the group consisting of a database, Internet, a hard drive, remote device, mobile device, and a server.

9. The method of claim 1, wherein the visual media content is selected from the group consisting of movies, movie clips, television shows, music videos, video games, Internet content, real-time feeds, celebrity photos, concept artwork, location shots, and behind-the-scenes photos.

10. The method of claim 1, wherein the visual media content comprises a scene from a movie during which the audio asset is played.

11. The method of claim 1, further comprising: automatically charging a user account for displaying the visual media content.

12. The method of claim 1, further comprising: providing an option to the user to place an order for the visual media content that is associated with the audio asset.

13. The method of claim 12, wherein the identified visual media content is displayed in response to receiving a user selection of the option.

14. The method of claim 1, further comprising:
providing an option to a user that allows the user to specify the type of visual media content that is displayed; and
restricting the search of the source to the type of visual media content specified by the user.

15. The method of claim 1, further comprising:
identifying a plurality of media assets that is related to the visual media content; and
displaying identifiers representing each of the plurality of media assets.

16. The method of claim 15, wherein the media assets are different from the visual media content.

17. The method of claim 15, further comprising, receiving a user selection of a media asset identifier and providing the media asset associated with the selected identifier.

18. The method of claim 15, wherein each of the plurality of media assets is selected from the group consisting of audio asset, visual media content, movies, television show, music videos, video games, print media assets and Internet video content.

19. The method of claim 1, further comprising:
transmitting data associated with the audio asset, in response to selection of an audio asset, to a third party service, wherein the searching and the associating are performed by the third party service.

20. The method of claim 1, wherein the searching comprises applying an audio recognition process that cross-references audio frequency data associated with the audio asset with audio frequency data associated with the visual media content.

21. The method of claim 19, wherein the third party service associates the audio asset with the visual media content by:
comparing meta-data associated with visual media content that is stored to a database with meta-data associated with the audio asset; and
matching visual media content with the audio asset based, at least in part, on the meta-data.

22. A method for associating audio assets and visual media comprising:
selecting an audio asset for playback;
searching a source to identify visual media content related to the selected audio asset;
associating the audio asset with the identified visual media content; and
displaying the visual media content associated with the audio asset during playback of the audio asset.

23. A system for associating audio assets and visual media comprising:
a processor configured to:
select an audio asset for playback;
in response to selecting the digital audio asset for playback, search a source to identify visual media content which includes at least a portion of the selected audio asset;
associate the audio asset with the identified visual media content; and
display the visual media content associated with the audio asset during playback of the audio asset.

24. The system of claim 23, wherein the processor is further configured to retrieve meta-data associated with the audio asset, and wherein the search is performed based on the retrieved meta-data.

25. The system of claim 24, wherein the meta-data associated with the audio asset is selected from the group consisting of: a title of the audio asset, artist name associated with the audio asset, and a date associated with the audio asset.

26. The system of claim 23, wherein the processor is further configured to:
search to identify a plurality of visual media content; and
associate the audio asset by linking the audio asset with one of the plurality of visual content.

27. The system of claim 23, wherein the processor is further configured to add an entry associated with the audio asset and an identifier for the identified visual media content that is linked to the entry to a database.

28. The system of claim 23, wherein the processor is further configured to search and associate continuously as the audio asset is being played back.

29. The system of claim 23, wherein the processor is further configured to repeat the search every time the audio asset is selected for playback.

30. The system of claim 23, wherein the source is selected from the group consisting of a database, Internet, a hard drive, remote device, mobile device, and a server.

31. The system of claim 23, wherein the visual content is selected from the group consisting of movies, movie clips, television shows, music videos, video games, Internet content, real-time feeds, celebrity photos, concept artwork, location shots, and behind-the-scenes photos.

32. The system of claim 23, wherein the visual content comprises a scene from a movie during which the audio asset is played.

33. The system of claim 23, wherein the processor is further configured to automatically charge a user account for displaying the visual media content.

34. The system of claim 23, wherein the processor is further configured to provide an option to the user to place an order for the visual media content that is associated with the audio asset.

35. The system of claim 34, wherein the processor is further configured to display the identified visual media content in response to receiving a user selection of the option.

36. The system of claim 23, wherein the processor is further configured to:
provide an option to a user that allows the user to specify the type of visual media content that is displayed; and
restrict the search of the source to the type of visual content specified by the user.

37. The system of claim 23, wherein the processor is further configured to:
identify a plurality of media assets that are related to the visual media content; and
display identifiers representing each of the plurality of media assets.

38. The system of claim 37, wherein the media assets are different from the visual media content.

39. The system of claim 37, wherein the processor is further configured to receive a user selection of a media asset identifier and provide the media asset associated with the selected identifier.

40. The system of claim 37, wherein each of the plurality of media assets is selected from the group consisting of audio assets, visual media content, movies, television shows, music videos, video games, print media assets and Internet video content.

41. The system of claim 23, wherein the processor is further configured to:
transmit data associated with the audio asset, in response to selection of the audio asset, to a third party service, wherein the search and the association are performed by the third party service.

42. The system of claim 23, wherein the search comprises applying an audio recognition process that cross-references audio frequency data associated with the audio asset with audio frequency data associated with the visual media content.

43. The system of claim 41, wherein the third party service associates the audio asset with the visual media content by:
comparing meta-data associated with visual media content that is stored to a database with meta-data associated with the audio asset; and
matching visual media content with the audio asset based, at least in part, on the meta-data.
